(19) United States
(12) Patent Application Publication
(10) Pub. No.: US 2007/0155192 A1
(43) Pub. Date: Jul. 5, 2007

(54) Module and method for estimating signal direction of arrival

(76) Inventors: Shiann Shiun Jeng, Jhongli City (TW); Chen Wan Tsung, Taichung City (TW); Yung Tzu Ting, Jhubei City (TW); Syue Ju Syue, Tainan City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/546,294

(22) Filed: Oct. 12, 2006

(30) Foreign Application Priority Data
Dec. 16, 2005 (TW) 094144674

(51) Int. Cl. H01R 39/00

(52) U.S. Cl. 439/13

(57) ABSTRACT

A module and a method for estimating signal direction of arrival are disclosed. The module consists of a processing unit and a direction finder. Using spatial signatures at different carrier frequencies, the processing unit generates a generating set of a subspace. Based on the generating set, the signal subspace is extended. Then, the direction finder estimates signal direction of arrival according to the signal subspace. The module for estimating signal direction of arrival of the present invention effectively reduces wrong estimation of the signal direction of arrival caused by loss of rank.

### BACKGROUND OF THE INVENTION

The present invention relates to a module and method for estimating direction of arrival (DOA), especially to a module and a method for estimating signal direction of arrival applied to a multicarrier modulation system.

Two techniques for a beamforming algorithm for a smart antenna system are beamforming algorithms respectively based on the signal direction of arrival and based on the spatial signature. In order to give correct beam pattern, the beamforming algorithm based on the signal direction of arrival needs to get the signal angle of arrival. As to algorithms for estimating signal direction of arrival such as multiple signal classification (MUSIC) or estimating signal parameter via rotational invariance techniques (ESPRIT), they estimate the direction of arrival by means of subspaces so as to give a beam pattern.

However, during transmission over wireless channels, direct path and multipath signals may interfere with one another and have high correlation due to reflection, diffraction or scattering. Owing to high correlation of the received signals, loss of rank may happen in the signal subspace. Thus the estimation algorithm for signal direction of arrival can't extend subspaces for estimating correct signal angle of arrival.

In order to solve problems of loss of rank in subspaces cause by signal correlation, a plurality of spatial smoothing algorithm is revealed such as forward-backward spatial smoothing (FBSS). While by the forward-backward spatial smoothing, the number of signal angle of arrival being estimated is 2M/3 and the M is number of antennas. On the restriction of the number of the antennas, the number of signal direction of arrival being estimated is not enough.

### SUMMARY OF THE INVENTION

It is therefore a primary object of the present invention to provide a module and a method for estimating signal direction of arrival that generate a spanning set of a subspace by means of multicarrier transmission for reducing signal relevance caused by multipath signal transmission and improving accuracy of the estimation.

It is another object of the present invention to provide a module and a method for estimating signal direction of arrival that generate a generating set of a subspace by spatial signature matrix formed from spatial signature vector at different subcarrier frequencies. Then a whole signal subspace is given by the generating set so as to improve wrong estimation of signal direction of arrival resulted from loss of rank in the subspace.

In order to achieve above objects, the present invention provides a module for estimating signal direction of arrival applied to estimate direction of arrival of the signal received by a smart antenna system. The signal includes a plurality of subcarrier frequencies while the module consists of a processing unit and a direction finder. According to different subcarrier frequencies and signal transmission paths, a plurality of spatial signature vectors corresponding to different subcarriers are obtained by the processing unit. By extension of the spatial signature matrix from the spatial signature vector corresponding to various subcarrier frequencies, a subspace is given. The column vector of the spatial signature matrix is from the spatial signature vector at different subcarrier frequencies. According to the above subspace, the direction finder estimates the direction of arrival of the signal received by the smart antenna system.

The above-mentioned smart antenna system includes an array antenna module that consists of a number of M receiving end antennas while M is a positive integer. Thus the spatial signature matrix is a generating set of the signal subspace with dimension of M and M is the rank of the generating set. Therefore, by means of the signal subspace extended from the spatial signature matrix, the above direction finder estimates angle of arrival of a number of M−1 signals.

In an embodiment, the way that the direction finder estimates the direction of arrival includes at least one of the multiple signal classification (MUSIC) or the estimating signal parameter via rotational invariance techniques (ESPRIT).

Furthermore, a method for estimating signal direction of arrival according to the present invention is applied to estimate direction of arrival of the signal received by a smart antenna system. The signal includes a plurality of subcarrier frequencies. The method including following steps: obtaining a spatial signature vector corresponding to the received signal according to the subcarrier frequency firstly while these spatial signature vectors correspond to different subcarrier frequencies; then extend to give a subspace of the received signal according to the spatial signature vectors corresponding to different subcarrier frequencies; estimate the signal direction of arrival when the signal is transmitted to the smart antenna system through direct path or multipath.

In summary, the signal subspace is extended by the spatial signature matrix so that the problem of loss of rank of the subspace caused by signal correlation can be avoided. Furthermore, the direction finder that operates based on the signal subspace estimates the signal direction of arrival more accurately.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a block diagram of an embodiment of a module for estimating signal direction of arrival according to the present invention;

FIG. 2 is a block diagram of another embodiment of a simulation system for estimating signal direction of arrival according to the present invention;

FIG. 3 is a flow chart of an embodiment of a method for estimating signal direction of arrival according to the present invention.

FIG. 4 shows simulation results of the embodiment in FIG. 2.

### DETAILED DESCRIPTION OF THE PREFERRED EMBODIMENT

In communication systems, correct estimation of signal direction of arrival is beneficial to beam pattern synthesis. Take a smart antenna applied to an Orthogonal Frequency Division Multiplexing (OFDM) system as an example, correct beam pattern is generated by accurate estimation of signal direction of arrival. The more number of angles of arrival the smart antenna system recognizes, the more correct the beam pattern given is when signals are transmitted to the smart antenna system through different pathways.

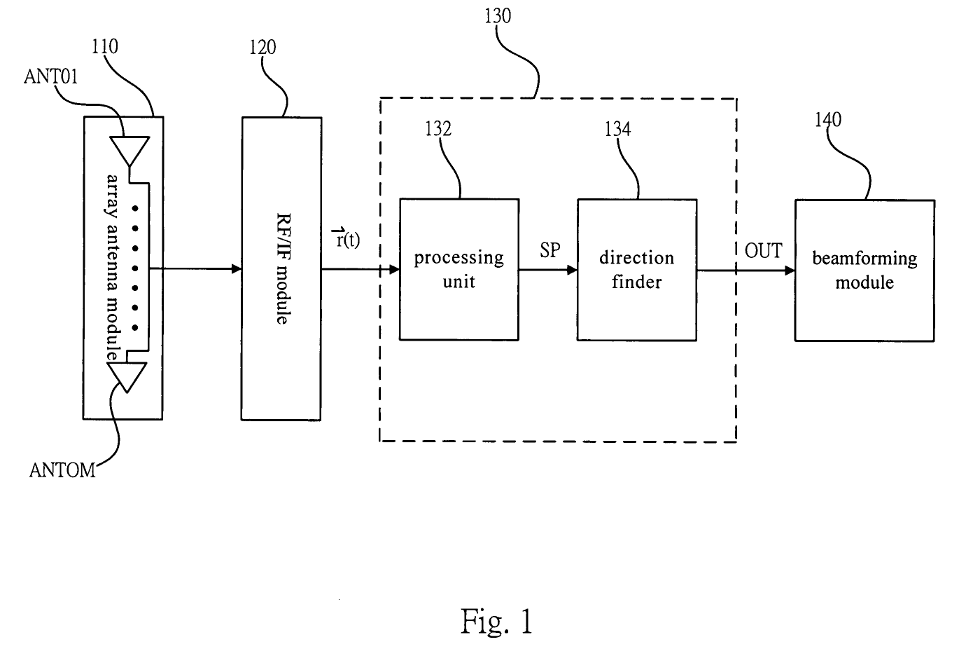

Refer to FIG. 1, an array antenna module 110 is coupled to a radio frequency/intermediate frequency (RF/IF) module 120 and DOA module 130 is coupled between the RF/IF module 120 and a beamforming module 140. The DOA module 130 consists of a processing unit 132 and a direction finder 134 that connect with each other. And the processing unit 132 is coupled to the RF/IF module 120 while the direction finder 134 is coupled to the beamforming module 140. Moreover, the array antenna module 110 includes a plurality of receiving end antennas ranging from ANT01 to ANT0M. The antennas can be omnidirectional, sector, or directional antenna, arranged linearly or circularly.

The array antenna module 110 is used to receive signal r̅(t). Take OFDM system as an example, the signal r̅(t) includes a plurality of subcarrier frequencies. After the array antenna module 110 receiving the signal r̅(t), the signal r̅(t) is sent to the processing unit 132 through the RF/IF module 120. Transmission of the signal r̅(t) through different pathways at various subcarrier frequencies generates different spatial signature vectors. By spectral-spatial smoothing algorithm, processing unit 132 obtains a spatial signature matrix formed from spatial signature vector at different subcarrier frequencies. In other words, column vector of the spatial signature matrix is from spatial signature vector at different subcarrier frequencies. By this spatial signature matrix, a subspace SP of the signal r̅(t) is extended and sent to the direction finder 134.

After receiving the subspace SP, the direction finder 134 uses algorithm for estimating signal angle of arrival such as multiple signal classification (MUSIC) or estimating signal parameter via rotational invariance techniques (ESPRIT) to estimate the angle of arrival of the signal r̅(t) and sends an output signal OUT to the beamforming module 140. The output signal OUT includes direction of arrival information related to the signal r̅(t). Then the beamforming module 140 produces a beam pattern of the signal r̅(t) according to the angle of arrival information related to the signal r̅(t). The more accurate the angle of arrival information is, the more correct the beam pattern produced by the beamforming module 140 is. In this embodiment, if the array antenna module 110 includes a number of M receiving end antennas, M is a positive integer, the number of angle of arrival that the direction finder 134 can estimate is M−1.

Next, spectral-spatial smoothing algorithm used in the processing unit 132 is described. In an embodiment, a smart antenna system applied to an Orthogonal Frequency Division Multiplexing system is taken as an example. It is assumed that signal is transmitted by a number of P subcarrier frequencies, P is a positive integer. The number of receiving end antennas ANT01˜ANT0M in the array antenna module 110 is M and M is a positive integer. The receiving end antennas ANT01˜ANT0M are arranged in a uniform linear fashion. Then the signal r̅(t) received by the array antenna module 110 having a spatial signature matrix A of a M×P matrix.

$$\begin{matrix}A = [ {\vec{a}}^{1} , {\vec{a}}^{2} , … , {\vec{a}}^{P} ] \\ = [ {\sum }_{l = 1}^{{N}_{m}} {\vec{a}}^{1} ( {θ}_{l} , {f}_{1} ) {\sum }_{l = 1}^{{N}_{m}} {\vec{a}}^{2} ( {θ}_{l} , {f}_{2} ) … {\sum }_{l = 1}^{{N}_{m}} {\vec{a}}^{P} ( {θ}_{l} , {f}_{P} ) ]\end{matrix} \qquad ( 1 )$$

$${\vec{a}}^{i} = {\sum }_{l = 1}^{{N}_{m}} {\vec{a}}_{l}^{i} ( {θ}_{l} , {f}_{1} )$$

is the spatial signature of the ith subcarrier frequency

$${\vec{a}}_{l}^{i} ( {θ}_{l} , {f}_{i} ) = [ {α}_{l}^{i} , {α}_{l}^{i} {e}^{j 2 π {f}_{i} sin {θ}_{l} \frac{D}{C}} , … , {α}_{l}^{i} {e}^{j 2 π {f}_{i} sin {θ}_{l} \frac{D}{C} ( M - 1 )} ]$$

is a M×1 vector

### P is the number of subcarrier frequency,

### Nₘ is the number of paths,

### C is light speed

### D is the distance between two of the receiving end antennas ANT01˜ANT0M,

θₗ is an angle of arrival of the lth path,
αₗⁱ is the amplitude and phase difference of the ith subcarrier's lth path,

### M is the number of the receiving end antenna,

### P must be larger than the number of antenna and the number of multipath signal

l, i is a positive integer

The above spatial signature matrix A can be converted into the following form:

$$A = [ \begin{matrix}{\sum }_{l = 1}^{{N}_{m}} {α}_{l}^{1} & {\sum }_{l = 1}^{{N}_{m}} {α}_{l}^{2} & ⋯ & {\sum }_{l = 1}^{{N}_{m}} {α}_{l}^{P} \\ {\sum }_{l = 1}^{{N}_{m}} {α}_{l}^{1} {e}^{j 2 π {f}_{1} sin {θ}_{l} \frac{D}{C}} & {\sum }_{l = 1}^{{N}_{m}} {α}_{l}^{2} {e}^{j 2 π {f}_{2} sin {θ}_{l} \frac{D}{C}} & ⋯ & {\sum }_{l = 1}^{{N}_{m}} {α}_{l}^{P} {e}^{j 2 π {f}_{P} sin {θ}_{l} \frac{D}{C}} \\ ⋮ & ⋮ & ⋰ & ⋮ \\ {\sum }_{l = 1}^{{N}_{m}} {α}_{l}^{1} {e}^{j 2 π {f}_{1} sin {θ}_{l} ( M - 1 ) \frac{D}{C}} & {\sum }_{l = 1}^{{N}_{m}} {α}_{l}^{2} {e}^{j 2 π {f}_{2} sin {θ}_{l} ( M - 1 ) \frac{D}{C}} & ⋯ & {\sum }_{l = 1}^{{N}_{m}} {α}_{l}^{P} {e}^{j 2 π {f}_{P} sin {θ}_{l} ( M - 1 ) \frac{D}{C}}\end{matrix} ] \qquad ( 2 )$$

In equation (2), the rank of the spatial signature matrix A is between 1 and M, that is

1≦r≦M (3)

wherein r is the rank of A, and r is a positive integer. In order to prove that the rank of the spatial signature matrix A is M and it is a generating set of the subspace with dimension, the spatial signature matrix A in equation (2) can be expressed as the sum of the antenna array response matrix A₁, . . . , A_{N}_{ₘ}. Thus the spatial signature matrix A can be converted into another form:

A=A₁+A₂+ . . . +A_{N}_{ₘ} (3)

The antenna array response matrix Aₗ of the lth multipath signal is

$${A}_{l} = [ \begin{matrix}{α}_{l}^{1} & {α}_{l}^{2} \\ {α}_{l}^{1} {e}^{j 2 π {f}_{1} sin {θ}_{l} ( \frac{D}{C} )} & {α}_{l}^{2} {e}^{j 2 π {f}_{2} sin {θ}_{l} ( \frac{D}{C} )} \\ ⋮ & ⋮ \\ {α}_{l}^{1} {e}^{j 2 π {f}_{1} sin {θ}_{l} ( \frac{D}{C} ) ( M - 1 )} & {α}_{l}^{2} {e}^{j 2 π {f}_{2} sin {θ}_{l} ( \frac{D}{C} ) ( M - 1 )}\end{matrix} \\ \begin{matrix}⋯ & {α}_{l}^{P} \\ ⋯ & {α}_{l}^{P} {e}^{j 2 π {f}_{P} sin {θ}_{l} ( \frac{D}{C} )} \\ ⋰ & ⋮ \\ ⋯ & {α}_{l}^{P} {e}^{j 2 π {f}_{P} sin {θ}_{l} ( \frac{D}{C} ) ( M - 1 )}\end{matrix} ] \qquad ( 4 )$$

In the equation (4), the antenna array response matrix Aₗ is composed of antenna array response vector, thus it can be converted to:

Aₗ=[āₗ¹(θₗ, ƒ₁) ā₁²(θₗ, ƒ₂) . . . āₗ^{P}(θₗ, ƒ_{P})] (5)

while

$${\vec{a}}_{l}^{i} ( {θ}_{l} , {f}_{i} ) is [ {α}_{l}^{i} , {α}_{l}^{i} {e}^{j 2 π {f}_{i} sin {θ}_{l} \frac{D}{C}} , … , {α}_{l}^{i} {e}^{j 2 π {f}_{i} sin {θ}_{l} \frac{D}{C} ( M - 1 )} ]$$

and āₗⁱ(θₗ, ƒᵢ) is converted into

$${\vec{a}}_{l}^{i} ( {θ}_{l} , {f}_{i} ) = {{α}_{l}^{i} [ 1 {e}^{j 2 π {f}_{i} sin {θ}_{l} ( \frac{D}{c} )} ⋯ {e}^{j 2 π {f}_{i} ( M - 1 ) sin {θ}_{l} ( \frac{D}{c} )} ]}^{T} \qquad ( 6 )$$

In consideration of the following matrix

$${Z}_{l} = [ \begin{matrix}1 & 1 & ⋯ & 1 \\ {e}^{j 2 π {f}_{1} sin {θ}_{l} ( \frac{D}{C} )} & {e}^{j 2 π {f}_{2} sin {θ}_{l} ( \frac{D}{C} )} & ⋯ & {e}^{j 2 π {f}_{P} sin {θ}_{l} ( \frac{D}{C} )} \\ ⋮ & ⋮ & ⋰ & ⋮ \\ {e}^{j 2 π {f}_{1} ( M - 1 ) sin {θ}_{l} ( \frac{D}{C} )} & {e}^{j 2 π {f}_{2} ( M - 1 ) sin {θ}_{l} ( \frac{D}{C} )} & ⋯ & {e}^{j 2 π {f}_{P} sin {θ}_{l} ( \frac{D}{C} )}\end{matrix} ] \qquad ( 7 )$$

In the equation (7), the matrix Zₗ is an M×P Vandermonde matrix and the Zₗ-dimension is M.

The matrix Zₗ includes a number of M independent column vector and the column vector of Zₗ multiplies a constant will not change independence and ranks of the column vectors. Thus rank of the matrix Aₗ is also M. In equation (3), the column vector of the spatial signature matrix A is a linear combination of the column vector corresponding to the antenna array response matrix A₁, . . . , A_{N}_{ₘ} because the spatial signature matrix A is the sum of the matrix A₁, . . . , A_{N}_{ₘ}.

Thus the ith column vector is converted to

$$\begin{matrix}{\vec{a}}^{i} = {\sum }_{l = 1}^{{N}_{m}} {\vec{a}}_{l}^{i} ( {θ}_{l} , {f}_{i} ) \\ = {\vec{a}}_{1}^{i} ( {θ}_{1} , {f}_{i} ) + {\vec{a}}_{2}^{i} ( {θ}_{2} , {f}_{i} ) + … + {\vec{a}}_{{N}_{m}}^{i} ( {θ}_{{N}_{m}} , {f}_{i} )\end{matrix} \qquad ( 8 )$$

In above description, the rank of the antenna array response matrix A₁, . . . , A_{N}_{ₘ} is M so that the dimension of the column vector of the spatial signature matrix A is M. According to above demonstration, the āⁱ in the equation (4) can be expressed as

$${\vec{a}}^{i} = {\sum }_{l = 1}^{{N}_{m}} {α}_{l}^{i} {\vec{b}}_{1} + {\sum }_{l = 1}^{{N}_{m}} {α}_{l}^{i} {e}^{j 2 π {f}_{i} sin {θ}_{t} \frac{D}{C}} {\vec{b}}_{2} + … + {\sum }_{l = 1}^{{N}_{m}} {α}_{l}^{i} {e}^{j 2 π {f}_{i} sin {θ}_{t} \frac{D}{C} ( M - 1 )} {\vec{b}}_{M} \qquad ( 9 )$$

while b̅ᵢ=[00 . . . 1 . . . 0]^{T}, the ith element is 1 while the rest element is 0.
A basis of B={ b̅₁ b̅₂ . . . b̅_{M}} represents all sets.

The basis of B represents all column vectors of the spatial signature matrix A from the equation (9). If a vector ν̅ is any one of vector in a vector space V with dimension M, the vector ν̅ is a linear combination of column vectors of the spatial signature matrix A and is expressed as:

$$\begin{matrix} \vec{v} = {β}_{1} {\vec{a}}_{1} + {β}_{2} {\vec{a}}_{2} + … + {β}_{P} {\vec{a}}_{P} \\ = {β}_{1} [ ( {\sum }_{l = 1}^{{N}_{m}} {α}_{l}^{1} ) {\vec{b}}_{1} + ( {\sum }_{l = 1}^{{N}_{m}} {α}_{l}^{1} {e}^{j 2 π {f}_{1} sin {θ}_{t} \frac{D}{C}} ) {\vec{b}}_{2} + … + \\ {\sum }_{l = 1}^{{N}_{m}} {α}_{l}^{1} {e}^{j 2 π {f}_{1} sin {θ}_{t} \frac{D}{C} ( M - 1 )} {\vec{b}}_{M} ] + \\ {β}_{2} [ ( {\sum }_{l = 1}^{{N}_{m}} {α}_{l}^{2} ) {\vec{b}}_{1} + ( {\sum }_{l = 1}^{{N}_{m}} {α}_{l}^{2} {e}^{j 2 π {f}_{2} sin {θ}_{t} \frac{D}{C}} ) {\vec{b}}_{2} + … + \\ {\sum }_{l = 1}^{{N}_{m}} {α}_{l}^{2} {e}^{j 2 π {f}_{2} sin {θ}_{t} \frac{D}{C} ( M - 1 )} {\vec{b}}_{M} ] + … + \\ {β}_{P} [ ( {\sum }_{l = 1}^{{N}_{m}} {α}_{l}^{P} ) {\vec{b}}_{1} + ( {\sum }_{l = 1}^{{N}_{m}} {α}_{l}^{P} {e}^{j 2 π {f}_{P} sin {θ}_{t} \frac{D}{C}} ) {\vec{b}}_{2} + … + \\ ( {\sum }_{l = 1}^{{N}_{m}} {α}_{l}^{P} {e}^{j 2 π {f}_{P} sin {θ}_{t} \frac{D}{C} ( M - 1 )} ) {\vec{b}}_{M} ]\end{matrix} \qquad ( 10 )$$

In equation (10), the vector ν̅ is converted into a linear combination of the basis B. Obviously, by selecting proper number β₁ . . . β_{P} any vector in the vector space V with dimension M can be given by linear combination of the column vectors of the spatial signature matrix A. Thus the equation (10) can be converted to

$$\vec{v} = [ ( {β}_{1} {\sum }_{l = 1}^{{N}_{m}} {α}_{l}^{1} + {β}_{2} {\sum }_{l = 1}^{{N}_{m}} {α}_{l}^{2} + … + {β}_{P} {\sum }_{l = 1}^{{N}_{m}} {α}_{l}^{P} ) ] {\vec{b}}_{1} + [ {β}_{1} ( {\sum }_{l = 1}^{{N}_{m}} {α}_{l}^{1} {e}^{j 2 π {f}_{1} sin {θ}_{t} \frac{D}{C}} ) + {β}_{2} ( {\sum }_{l = 1}^{{N}_{m}} {α}_{l}^{2} {e}^{j 2 π {f}_{2} sin {θ}_{t} \frac{D}{C}} ) + … + {β}_{P} ( {\sum }_{l = 1}^{{N}_{m}} {α}_{l}^{P} {e}^{j 2 π {f}_{P} sin {θ}_{t} \frac{D}{C}} ) ] {\vec{b}}_{2} + … + [ {β}_{1} ( {\sum }_{l = 1}^{{N}_{m}} {α}_{l}^{1} {e}^{j 2 π {f}_{1} sin {θ}_{t} \frac{D}{C} ( M - 1 )} ) + {β}_{2} ( {\sum }_{l = 1}^{{N}_{m}} {α}_{l}^{2} {e}^{j 2 π {f}_{2} sin {θ}_{t} \frac{D}{C} ( M - 1 )} ) + … + {β}_{P} ( {\sum }_{l = 1}^{{N}_{m}} {α}_{l}^{P} {e}^{j 2 π {f}_{P} sin {θ}_{t} \frac{D}{C} ( M - 1 )} ) ] {\vec{b}}_{M} \qquad ( 11 )$$

Therefore, a set of column vectors of the spatial signature matrix A is a generating set of the vector space V with dimension M while M is the rank of this generating set. The processing unit 132 uses the column vector of the spatial signature matrix A to extend the subspace SP so as to solve problems of loss of rank of the subspace SP caused by multipath transmission. After receiving the subspace SP extended from the column vector of the spatial signature matrix A, the direction finder 134 estimates the direction of arrival.

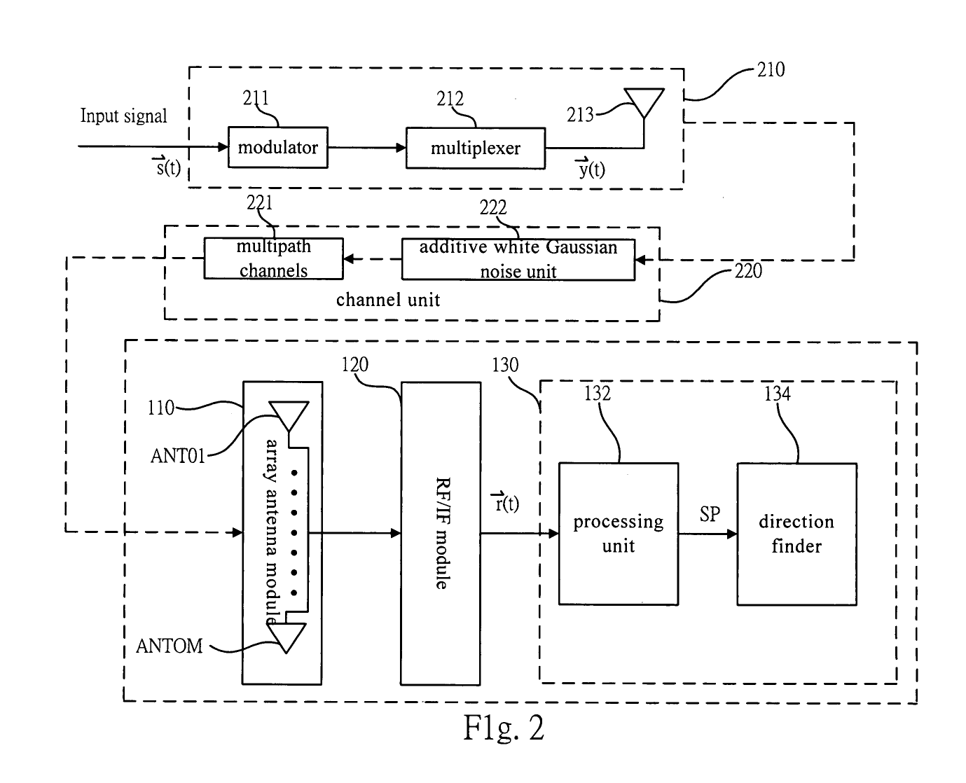

The accuracy of the method for estimating signal direction of arrival is proved by simulation. As shown in FIG. 2, the system for estimating signal direction of arrival includes 3 parts—an emitting unit 210, a channel unit 220 and a receiving unit 230. The emitting unit 210 is composed of a modulator 211, a multiplexer 212 and a transmitting antenna 213. The multiplexer 212 is disposed between the modulator 211 and the transmitting antenna 213. The channel unit 220 consists of an additive white Gaussian noise unit 222 and multipath channels 221. The receiving unit 230 includes an array antenna module 110, a radio frequency/intermediate frequency (RF/IF) module 120 and a DOA module 130. The array antenna module 110 is coupled to the RF/IF module 120 while the DOA module 130 is coupled between the RF/IF module 120 and a beamforming module 140. The DOA module 130 is composed of a processing unit 132 and a direction finder 134 that connect with each other. And the processing unit 132 is coupled to the RF/IF module 120 while the direction finder 134 is coupled to the beamforming module 140. Furthermore, the array antenna module 110 includes a plurality of receiving end antennas from ANT01 to ANT0M. The receiving unit 230 has similar parts as embodiment in FIG. 1 and the way of signal transmission and connecting components are also the same.

A transmitted signal y̅(t) with multiple subcarriers is generated by an input signal s(t) passing through the modulator 211 and the multiplexer 212 and is transmitted by the transmitting antenna 213. Then the transmitted signal y̅(t) is added with white noise n̅(t) by the additive white Gaussian noise unit 222 for simulating influence of environmental noises on the signal y̅(t). Next through the multipath channels 221, channel effects of the signal y̅(t) transmitted through multiple paths are simulated. Thus the signal r̅(t) received by the array antenna module 110 is expressed as:

r̅(t)=A y̅(t)+ n̅(t)

wherein the column vector of the spatial signature matrix A respectively is spatial signature vector formed by transmission of the signal y̅(t) through multiple path at various subcarriers. Then by the processing unit 132, the signal r̅(t) is sent to the processing unit 132 through the RF/IF module 120. The processing unit 132 is in charge to process the signal r̅(t) to get the spatial signature matrix A and outputs subspace SP of the signal r̅(t) to the direction finder 134. according to the spatial signature matrix A. By means of an algorithm for estimating signal direction of arrival such as Total Least Squares ESPRIT (TLS ESPRIT), the direction finder 134 estimates angle of arrival of the signal r̅(t) according to the subspace SP. The angle of arrival of the signal r̅(t) is generated by a source of randomness. Take Laplacian distribution as an example, in this embodiment, the angle of arrival respectively are 40.2423°, 23.8428° and 18.3726°.

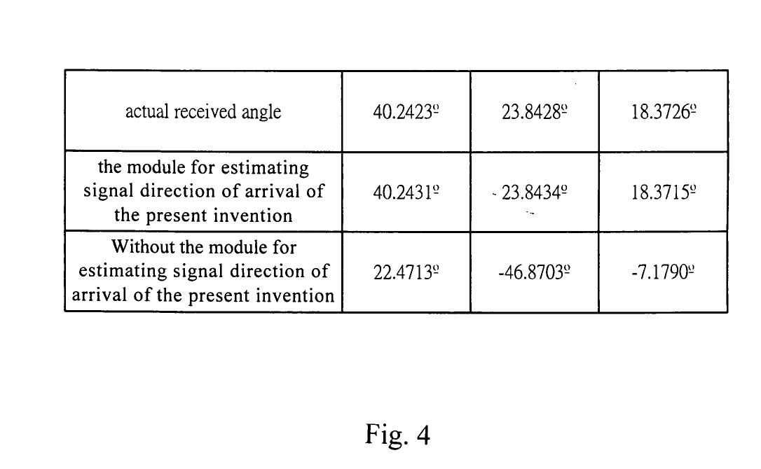

FIG. 4 shows simulation results of the embodiment. In this Figure, the actual received angle is angle of arrival of the signal r̅(t), respectively are 40.2423°, 23.8428° and 18.3726° while angle of arrival of the signal r̅(t) obtained by the module for estimating signal direction of arrival of the present invention are 40.2431°, 23.8434° and 18.3715°. Without the module of the present invention, the estimated results of the angle of arrival of the signal r̅(t) only by the algorithm of the direction finder 134 such as TLS ESPRIT are respectively 22.4713°, −46.8703° and −7.1790. Therefore, by means of the present invention, the accuracy of the direction of arrival of the signal r̅(t) is improved and the error is less than 0.1%.

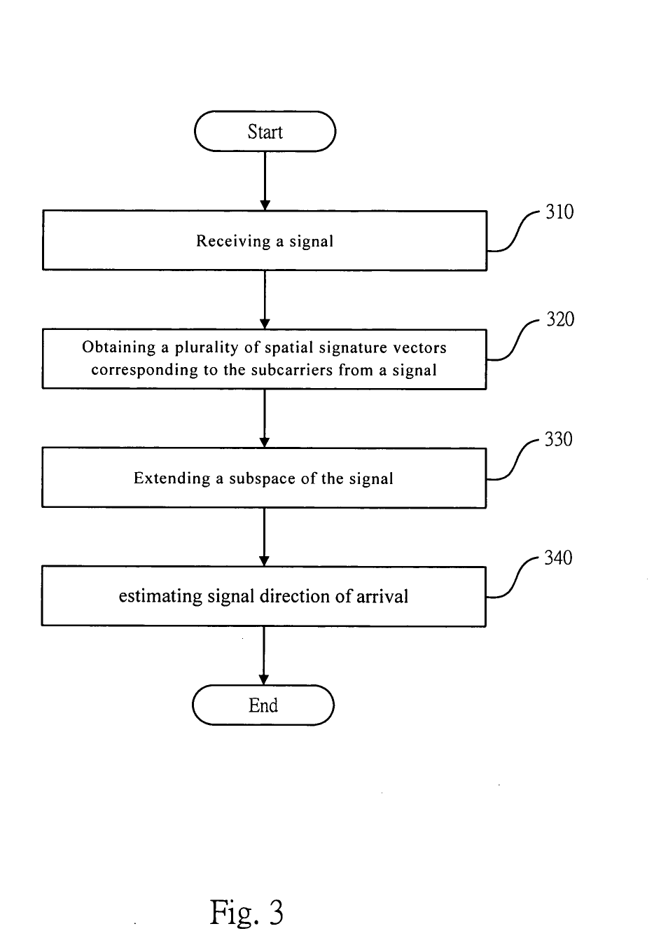

Refer to FIG. 3, a method for estimating signal direction of arrival according to the present invention is applied to detect the direction of arrival of signal r̅(t) received by a smart antenna system. The signal r̅(t) includes a plurality of subcarriers. First, refer to step 310, the array antenna module 110 receives a signal r̅(t). Then in step S320, the processing unit 132 obtains a spatial signature matrix composed of a plurality of spatial signature vectors corresponding to the subcarriers according to various subcarriers and signal transmission paths. In other words, the column vector of the spatial signature matrix is formed by the plurality of spatial signature vectors and each spatial signature vector corresponds to a subcarrier. Next, in step S330, according to the obtained spatial signature matrix, the processing unit 132 extends a subspace of the signal r̅(t) for estimating direction of arrival of the signal r̅(t). The directional of arrival includes at least one of the angle of arrival of the signal r̅(t) or signal strength.

The above smart antenna system includes an array antenna module that consists of a number of M receiving end antennas, M is a positive integer. If the dimension of the subspace is M, a set of column vectors of the spatial signature matrix is a generating set of the above signal subspace and M is the rank of the generating set.

In another embodiment, the method for extending the subspace in the step 330 includes a spectral-spatial smoothing algorithm. While in the step 340, the method for estimating signal direction of arrival includes at least one of the multiple signal classification (MUSIC) or the estimating signal parameter via rotational invariance techniques.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A module for estimating signal direction of arrival applied to estimate direction of arrival of a signal received by a smart antenna system comprising a processing unit and a direction finder;
a processing unit obtaining a spatial signature matrix corresponding to the signal and extend a subspace of the signal according to a plurality of column vectors of the spatial signature matrix of the signal; and a direction finder estimating direction of arrival of the signal received by the smart antenna system according to the subspace of the signal; wherein the signal having a plurality of subcarrier frequencies and the plurality of column vectors of the spatial signature matrix of the signal correspond to the subcarrier frequencies respectively.

2. The module as claimed in claim 1, wherein the direction of arrival of the signal is the direction of arrival of the signal received by the smart antenna system when the signal is transmitted to the smart antenna system through a direct path.

3. The module as claimed in claim 1, wherein the direction of arrival of the signal is the direction of arrival of the signal received by the smart antenna system when the signal is transmitted to the smart antenna system through multipath.

4. The module as claimed in claim 1, wherein the smart antenna module having an array antenna module that includes a number of M receiving end antennas while M is a positive integer.

5. The module as claimed in claim 4, wherein if dimension of the signal subspace is M, a set of the column vectors of the spatial signature matrix is a generating set of the signal subspace and M is the rank of the generating set.

6. The module as claimed in claim 1, wherein methods that the processing unit uses for extending the subspace of the signal include a spectral-spatial smoothing algorithm.

7. The module as claimed in claim 1, wherein the way that the direction finder estimates direction of arrival of the signal includes at least one of the multiple signal classification (MUSIC) or estimating signal parameter via rotational invariance techniques (ESPRIT).

8. A method for estimating signal direction of arrival applied to estimate direction of arrival of a signal received by a smart antenna system and the signal having a plurality of subcarrier frequencies comprising the steps of:
obtaining a spatial signature matrix corresponding to the signal according to each of the subcarrier frequencies; a plurality of column vectors of the spatial signature matrix correspond to the subcarrier frequencies respectively;
extending a subspace of the signal according to the plurality of column vectors of the spatial signature matrix of the signal; and
estimating direction of arrival of the signal received by the smart antenna system according to the subspace of the signal.

9. The method as claimed in claim 8, wherein the direction of arrival of the signal is the direction of arrival of the signal received by the smart antenna system when the signal is transmitted to the smart antenna system through a direct path.

10. The method as claimed in claim 8, wherein the direction of arrival of the signal is the direction of arrival of the signal received by the smart antenna system when the signal is transmitted to the smart antenna system through multipath.

11. The method as claimed in claim 8, wherein the smart antenna module having an array antenna module that includes a number of M receiving end antennas while M is a positive integer.

12. The method as claimed in claim 11, wherein if dimension of the signal subspace is M, a set of the column vectors of the spatial signature matrix of the signal is a generating set of the signal subspace and M is the rank of the generating set.

13. The method as claimed in claim 8, wherein in the step of extending a subspace of the signal according to the plurality of column vectors of the spatial signature matrix of the signal, methods for extending include a spectral-spatial smoothing algorithm.

14. The method as claimed in claim 8, wherein in the step of estimating direction of arrival of the signal received by the smart antenna system according to the subspace of the signal, methods for estimating direction of arrival of the signal includes at least one of the multiple signal classification (MUSIC) or estimating signal parameter via rotational invariance techniques (ESPRIT).
